(19) United States
(12) Patent Application Publication
(10) Pub. No.: US 2008/0164694 A1
(43) Pub. Date: Jul. 10, 2008

(54) CONNECTION FOR POLYMER COATED TUBING

(76) Inventors: Michael Zdroik, Metamora, MI (US); Robert Doherty, Syracuse, IN (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/621,749

(22) Filed: Jan. 10, 2007

(51) Int. Cl. F16L 25/00; F02M 69/46

(52) U.S. Cl. 285/331; 123/456

(57) ABSTRACT

A connection arrangement for a tube is provided. The invention connection arrangement comprises a device configured to communicate fluid from an inlet to an outlet wherein the device includes at least one fitting having a plurality of protrusions extending therefrom. The connection arrangement further includes a polymer coated tube comprising aluminum material coupled with the fitting of the device, and the tube is configured to communicate matter with the device. The tube has an outer surface, an inner surface, at least one open end, a center passageway, a longitudinal axis extending through the center passageway, and a polymer coating. When mated together, the protrusions of the fitting create a tight seal and connection between the fitting and the tube.

### FIELD OF THE INVENTION

The field of the present invention is polymer coated tubing. More particularly, the present invention relates to methods for connecting polymer coated tubing comprising aluminum material used in applications such as fuel systems, for example, in which a fluid (i.e., liquid or gas) is communicated through the tubing.

### BACKGROUND OF THE INVENTION

Many systems in which fluid (i.e., liquid and/or gas) is communicated amongst components of the system use tubing to connect the various components to allow for the communication of the fluid therebetween. One particular type of tubing that has many practical applications is nylon coated aluminum alloy tubing such as that offered by Hydro Aluminum Precision Tubing of Tonder, Denmark, under the trademark HYCOT®, for example. Common applications for this type of tubing include, but are not limited to, power steering systems, air condition systems, brake systems, oil cooler systems, and vehicular fuel systems, to name but a few.

There are many advantages to using nylon coated aluminum alloy tubing in these and other applications. For example, this type of tubing is more robust than other types of tubing and less susceptible to high temperature and abrasions that may occur during the operation or servicing of the systems in which the tubing is used. Accordingly, the risk of damage to the tubing during servicing and testing of the system in which the tubing is incorporated, or other systems surrounding the tubing, is substantially reduced. These advantages are particularly important in the field of fuel systems where the tubing could be cut or ruptured during service/testing. An additional advantage is that nylon coated aluminum alloy tubing reduces the amount hydrocarbons that permeate therefrom as compared to conventional tubing, such as, for example, multi-layer tubing that is often used in fuel delivery systems.

However, along with the many advantages to using nylon coated aluminum alloy tubing, there are many disadvantages in the conventional means of connecting such tubing to various devices or to other tubing in a system. For example, one conventional method of connecting two pieces of nylon coated aluminum alloy tubing together is by way of a “quick-connect.” In this type of connection, at least one end of one piece of tubing is sized so as to be inserted or “snapped” into an opening in one end of the second piece of tubing. In such a connection, one or more O-rings are typically required in order to seal the joint created between the two pieces of tubing. This sealing function is important so that leak paths for the fluid (i.e., liquid or gas) flowing through the connected tubes are prevented, or at least substantially reduced. Similarly, in the case of fuel delivery systems, for example, the seal acts to prevent the permeation of hydrocarbons through the connection joint. While ostensibly reducing risks, such arrangements are disadvantageous because of the number of parts required to make the connection (i.e., one or more O-rings), which increases costs for the overall system.

Accordingly, there is a need for a method and arrangement of connecting nylon coated tubing that will minimize and/or eliminate one or more of the above-identified deficiencies.

### SUMMARY OF THE INVENTION

The present invention is directed toward a connection arrangement for a polymer coated tube comprising aluminum material.

In accordance with one embodiment of the invention, the connection arrangement comprises a device configured to communicate fluid (i.e., a liquid or gas) from an inlet to an outlet. The device includes at least one fitting having a plurality of protrusions extending therefrom. The inventive connection arrangement further includes a polymer coated tube comprising aluminum material to communicate the fluid to and/or from the device. Accordingly, the polymer coated tube is coupled with the fitting of the device to allow for such communication. When the tube and device are mated together, the protrusions of the fitting create a tight seal and connection between the fitting and the tube. The polymer coated tube includes an outer surface, an inner surface, at least one open end, a center passageway, and a longitudinal axis extending therethrough.

Further features and advantages of the present invention will become more apparent to those skilled in the art after a review of the invention as it is shown in the accompanying drawings and detailed description.

### BRIEF DESCRIPTION OF THE DRAWINGS

FIG. 1 is a perspective view of an exemplary fuel delivery system in accordance with the present invention.

FIG. 2 is a cross-section view of a polymer coated tube in accordance with the present invention.

FIG. 3 is a cross-section view of an exemplary fitting having a male portion in accordance with the present invention.

FIG. 4 is a cross-section view of the end of the polymer coated tube illustrated in FIG. 2.

FIG. 5A is a perspective view of a connection between the fitting illustrated in FIG. 3 and the polymer coated tube illustrated in FIGS. 2 and 4 in accordance with the present invention.

FIG. 5B is a cross-section view of the connection illustrated in FIG. 5A taken along the line 5B-5B in FIG. 5A.

FIG. 5C is a cross-section view of an alternate exemplary fitting having a male portion in accordance with the present invention.

FIG. 5D is a cross-section view of a connection between the fitting of FIG. 5C and the polymer coated tube illustrated in FIGS. 2 and 4 in accordance with the present invention.

FIG. 6A is a perspective view of an exemplary fitting having a female portion in accordance with the present invention.

FIG. 6B is a cross-section view of the exemplary fitting illustrated in FIG. 6A taken along the line 6B-6B in FIG. 6A.

FIG. 7A is a perspective view of a connection between the fitting illustrated in FIG. 6A and a polymer coated tube in accordance with the present invention.

FIG. 7B is a cross-section view of the connection illustrated in FIG. 7A taken along the line 7B-7B in FIG. 7A.

FIG. 8A is a perspective view of an exemplary fitting having male and female portions in accordance with the present invention.

FIG. 8B is a cross-section view of the fitting illustrated in FIG. 8A taken along the line 8B-8B in FIG. 8A.

FIG. 9A is a perspective view of a connection between the fitting illustrated in FIG. 8A and the polymer coated tube illustrated in FIGS. 2 and 4 in accordance with the present invention.

FIG. 9B is a cross-section view of the connection illustrated in FIG. 9A taken along the line 9B-9B in FIG. 9A.

FIG. 10A-10D are flow diagrams illustrating exemplary embodiments of a method of connecting a polymer coated tube to a device in accordance with the present invention.

FIG. 11A is a cross-section view of an alternate exemplary fitting having a male portion in accordance with the present invention.

FIG. 11B is a cross-section view of a connection between the fitting of FIG. 11A and the polymer coated tube illustrated in FIGS. 2 and 4 in accordance with the present invention.

FIG. 12A is a cross-section view of an alternate exemplary fitting having a female portion in accordance with the present invention.

FIG. 12B is a cross-section view of the connection between the fitting of FIG. 12A and a polymer coated tube.

FIG. 13A is a cross-section view of an alternate exemplary fitting having male and female portions in accordance with the present invention.

FIG. 13B is a cross-section view of the connection between the fitting of FIG. 13A and the polymer coated tube of FIGS. 2 and 4 in accordance with the present invention.

### DETAILED DESCRIPTION OF THE INVENTION

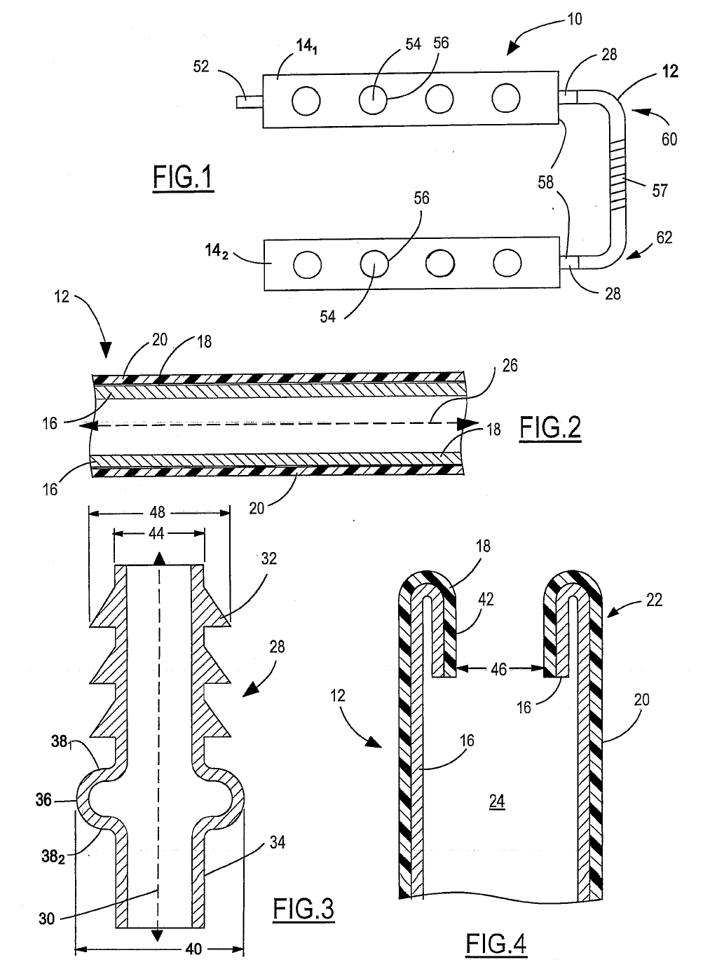

Referring now to the drawings wherein like reference numerals are used to identify identical components in the various views, FIG. 1 illustrates one embodiment of a connection arrangement 10 between a polymer coated tube 12 and a device 14, such as, for example, a pair of fuel rails 14₁, 14₂ for a vehicular fuel delivery system. For case of description, the application in connection with which the claimed apparatus and method will be described is often that of a vehicular fuel system. It should be noted that while the description below may be so limited, it is being done so for illustrative purposes only. Accordingly, the inventive apparatus and method are not limited to vehicular fuel systems, but rather can be applied in a wide range of systems in which fluid (i.e., liquid or gas) is communicated, all of which remain within the spirit and scope of the present invention.

In a preferred embodiment, polymer coated tube 12 is a co-extruded polymer coated tube comprising aluminum material. However, it should be noted that it is not intended that tube 12 be so limited. Rather, any tube having a polymer coating remains within the spirit and scope of the present invention. Tube 12 is capable of communicating various types of fluid in either a liquid or gaseous state, such as, for example, fuel, water or vapor between two devices.

As shown in FIG. 2, tube 12 includes an extruded core 16, a bonded interface layer 18, and a polymer outer layer 20. In one preferred embodiment, core 16 is formed of aluminum material such as an aluminum alloy. For example, in one particular embodiment, the aluminum material is 3000 series aluminum (i.e., manganese is the major alloying component). In an alternate embodiment, the aluminum material is 5000 series aluminum (i.e., magnesium is the major alloying components). In yet another alternate embodiment, the aluminum material is 6000 series aluminum (i.e., magnesium and silicon are the major alloying components). Accordingly, core 16 can take the form of many different materials of which aluminum is a part, including, but not limited to, those identified with particularity above.

In one preferred embodiment, nylon outer layer 20 is formed of “polyamide 12” (commonly known in the art as “PA 12” or “nylon 12”), however, any suitable polymer coating can be used. For example, in alternate embodiments layer 20 can be formed of one of any number of thermoplastics, such as, for example “polyamide 6”, “polyamide 6.6”, “polyamide 11”, polyphenylene sulfide (PPS), polyphthalamide (PPA), and polybutylene napthalate (PBN), for example. It should be noted, however, that this list is meant to be for exemplary purposes only and not intended to be all inclusive. Accordingly, those of ordinary skill in the art will recognize that other polymer materials exist that can be used to create polymer layer 20.

With reference to FIGS. 2 and 4, tube 12 further includes at least one open end 22, a central passageway 24 through which the aforementioned fluid (i.e., liquid or gas) can flow, and a longitudinal axis 26 extending therethrough. An exemplary example of such a polymer coated tube is that offered by Hydro Aluminum Precision Tubing of Tonder, Denmark, under the trademark HYCOT®. Tube 12 may take on a number of forms, such as, for exemplary purposes only, a tubular fuel rail, a tube for connecting a fuel rail to a fuel source, and for connecting two fuel rails together (i.e., a crossover tube), as shown in FIG. 1.

Device 14, in its most general form, is configured to communicate various types of fluid in either a liquid (i.e., fuel, water, etc.) or gaseous (i.e., vapor) state to and from tube 12. Device 14 may take on a number of forms, such as, for exemplary purposes only, another piece of tubing (polymer coated or not), a fuel source, a fuel rail, or a tube for connecting a fuel rail to a fuel source or to another fuel rail. In the embodiment where device 14 takes the form of a fuel rail or a tube connecting a fuel rail to a fuel source or another fuel rail, the fluid comprises liquid fuel. In a preferred embodiment, device 14 includes at least one fitting 28 having a longitudinal axis 30, and a plurality of protrusions 32 protruding therefrom. Fitting 28 is configured for mating with open end 22 of tube 12 and to allow for the fluid (i.e., liquid or gas) communicated between tube 12 an device 14 to flow therethrough. In a preferred embodiment, for reasons described in greater detail below, fitting 28 and protrusions 32 are formed of a material that is sufficiently harder than the material comprising layer 20, such as, for exemplary purposes only, stainless steel, low carbon steel or aluminum. Additionally, in a preferred embodiment, fitting 28 is mechanically coupled to an outlet of device 14 by, for example, known brazing or welding operations. However, it should be noted that in alternate embodiments, fitting 28 may be integral with device 14 or otherwise mechanically coupled therewith using other attachment means known in the art.

In a preferred embodiment illustrated in FIG. 3, fitting 28 has a male portion 34, and protrusions 32 protrude from the outer surface thereof in a radially outward direction relative to axis 30. As will be described in greater detail below, in one exemplary embodiment, male portion 34 includes a stop feature 36, which comprises a pair of stop surfaces 38₁, 38₂, and which has an outer diameter 40. It should be noted, however, that in other alternate embodiments, this stop feature may have a different configuration or may not be included at all.

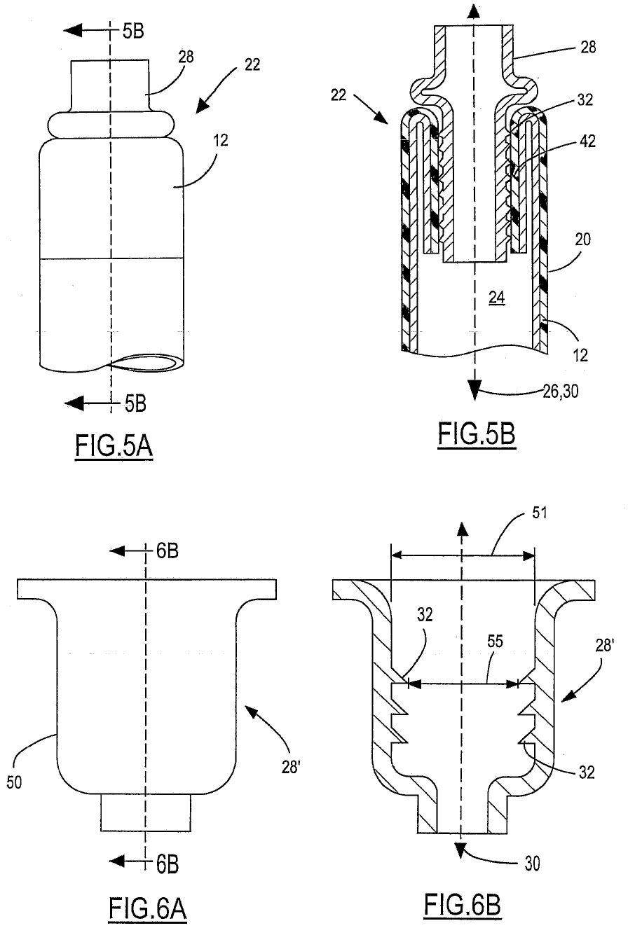

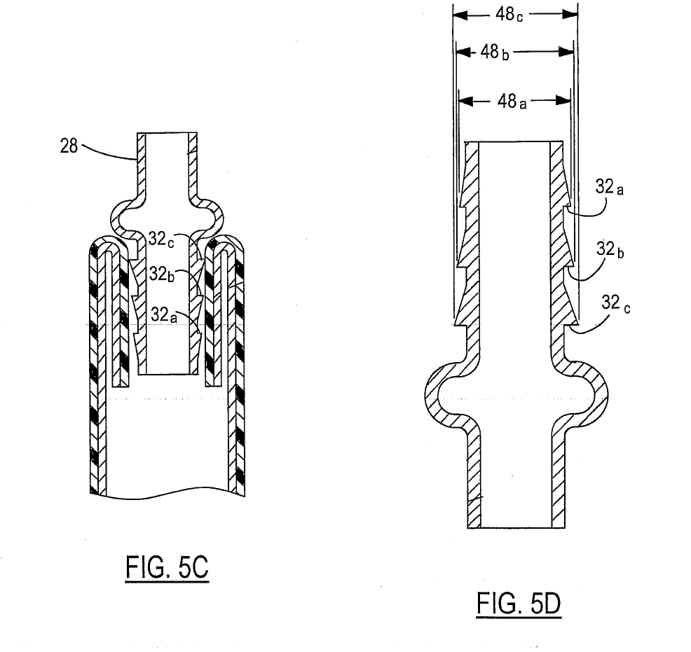

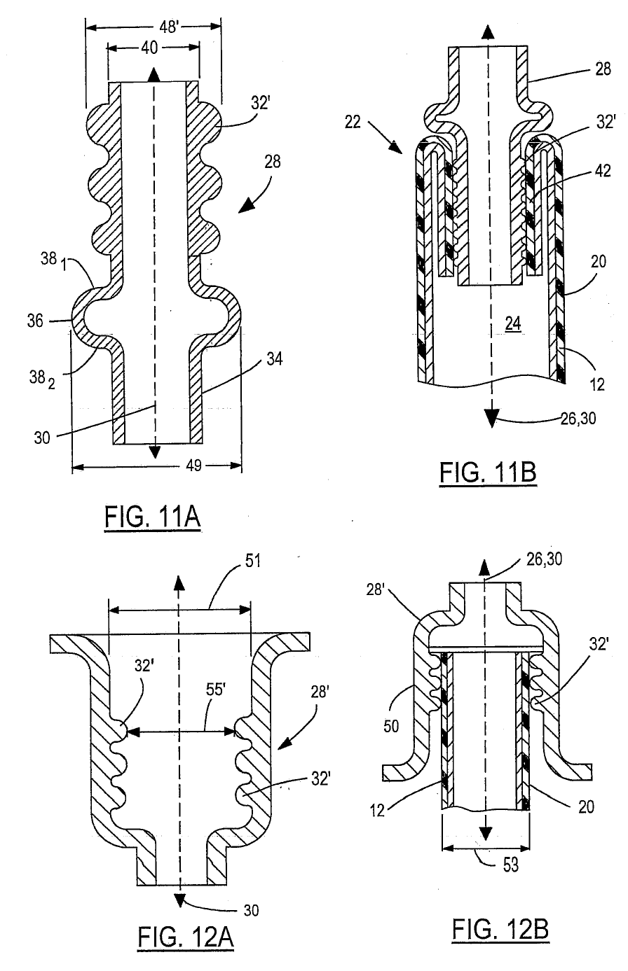

In the illustrated embodiment of FIG. 4, a polymer layer 42 is disposed on a portion of the inner surface of tube 12 proximate the open end 22 of tube 12. In a preferred embodiment, layer 42 is a nylon layer formed of “polyamide 12.” In accordance with one preferred embodiment, layer 42 is created by performing a known rolling or folding process on tube 12 in which the end of tube 12 is rolled in a radially inwardly direction into the center passageway 24 of tube 12. The result of this rolling operation is that a portion of polymer layer 20 is disposed on the inside of tube 12, thereby forming polymer layer 42. In this embodiment, the combined rolled portion of core 16 and polymer layer 42 is generally parallel to the inner wall of tube 12. As shown in FIGS. 5A, 5B and 11B, to connect tube 12 an device 14 (not shown), the rolled end of tube 12 is press-fit over male portion 34 of fitting 28, and thus, protrusions 32, in an axial direction relative to both longitudinal axes 26 and 30. Thus, in this embodiment, the body diameter 44 of fitting 28 is less than the inside diameter 46 (shown in FIG. 4) of tube 12 at the rolled end thereof.

In a first exemplary embodiment illustrated in FIGS. 5A and 5B wherein protrusions 32 take the form of barbs, as the end of tube 12 is pressed onto fitting 28, protrusions 32 penetrate and embed into polymer layer 42 disposed within the interior of center passageway 24. When protrusions 32 penetrate polymer layer 42, portions of layer 42 are caused to be displaced so as to surround protrusions 32. Accordingly, a secure and sealed connection between tube 12 and device 14 is created and maintained due to the elasticity of the polymer layer 42. As will be understood by one of ordinary skill in the art, protrusions 32 are circumferential in extent and are configured to allow insertion. Once embedded, however, protrusions 32 are configured to resist removal. Accordingly, the radially outermost extent of protrusions 32 have a diameter 48 (shown in FIG. 3) that is larger, if only slightly, than the inside diameter 46 of the rolled end of tube 12.

In a second exemplary embodiment illustrated in FIGS. 11A and 11B wherein protrusions 32′ have a bead or ridge shape, as the end of tube 12 is pressed onto fitting 28, protrusions 32′ press, but do not penetrate, into layer 42. When protrusions 32′ press into layer 42, portions of layer 42 are caused to be displaced so as to surround protrusions 32′. Accordingly, a tight seal and connection between fitting 28 and tube 12 is created and maintained due to the elasticity of polymer layer 42. Accordingly, the radially outermost extent of protrusions 32′ have a diameter 48′ that is larger, if only slightly, than the inside diameter 46 (shown in FIG. 4) of the rolled end of tube 12. This embodiment is especially suited for systems wherein tube 12 has a relatively thin polymer coating (i.e., on the order of 0-500 μm, for example) such that the barbs described above could potentially damage or otherwise compromise the integrity of the coating. Thus, in this embodiment, protrusions 32′ serve to create a tight connection without penetrating and embedding into the polymer layer.

Whether the protrusions take the form of the barbs or ridges described above, in an alternate preferred embodiment illustrated in FIGS. 5C and 5D, the protrusions 32 (i.e., 32ₐ, 32_{b}, 32_{c}, etc.) of male member 34 each have a different diameter (i.e., 48ₐ, 48b, 48c, etc.). As illustrated in FIG. 5C, a first protrusion 32ₐ has a diameter 48ₐ; a second protrusion 32_{b} has a diameter 48_{b} that is greater than diameter 48ₐ; and a third protrusion 32_{c} has a diameter 48_{c} that is greater than both diameters 48ₐ and 48_{b}. Accordingly, as the rolled end 22 of tube 12 is press-fit over male portion 34, the diameter of each successive protrusion increases so that the first protrusions over which tube 12 is press-fit are the lesser diameter protrusions, and the protrusions having progressively increased diameters are the latter protrusions so that the first protrusions over which tube 12 is press-fit do not upset the inner surface of tube 12, and layer 42 in particular, for the other protrusions over which tube 12 is press-fit. Thus, the sealing and connection functions of the protrusions will be optimized, as will be described in greater detail below.

As briefly discussed above and as shown in FIG. 3, fitting 28, and more specifically male portion 34, includes stop feature 36. Stop feature 36 is operative to limit the insertion depth of fitting 28 into the rolled end 22 of tube 12. Thus, when stop surface 38₁ of stop feature 36 contacts the end of tube 12, fitting 28 is fully inserted. Accordingly, the diameter 40 of stop feature 36 is substantially larger than the inside diameter 46 of the rolled end of tube 12 to perform this limiting function.

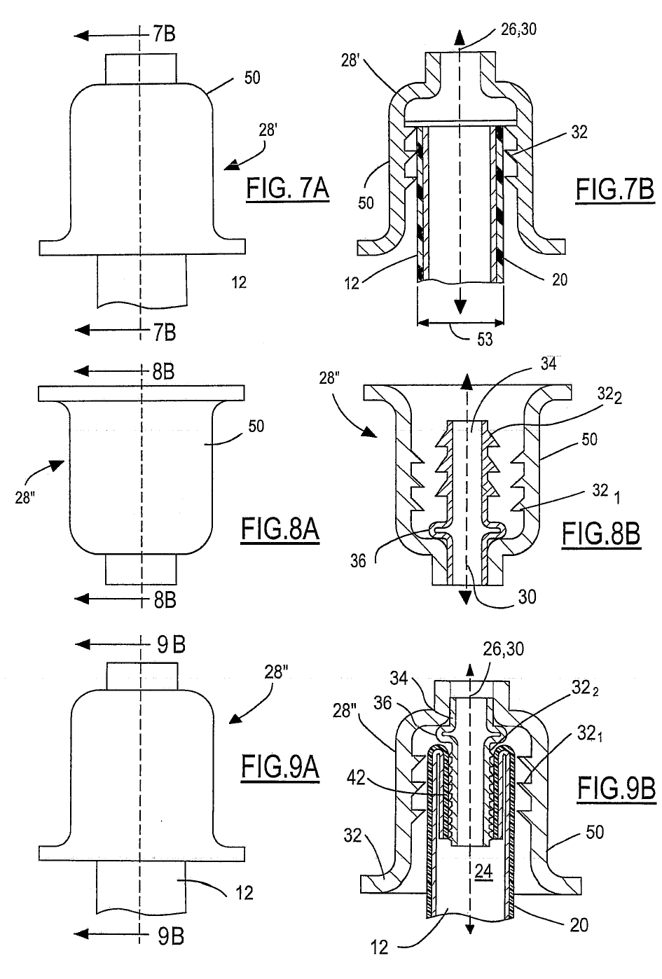

In an alternate preferred embodiment illustrated in FIGS. 6A, 6B, 7A, 7B, 12A and 12B, fitting 28′ has a female portion 50, and protrusions 32 protrude from the inner surface of female portion 50. To connect tube 12 and device 14, open end 22 of tube 12, which may or may not be the tube illustrated in FIG. 4, is inserted and press-fit into female portion 50 of fitting 28′ in an axial direction relative to longitudinal axes 26, 30. Thus, in this embodiment, the diameter 51 (shown in FIG. 6B) of the opening of female portion 50 of fitting 28′ is greater than the outside diameter 53 (shown in FIG. 7B) of tube 12.

In a first exemplary embodiment illustrated in FIGS. 6A, 6B, 7A and 7B wherein protrusions 32 take the form of barbs, as the end of tube 12 is inserted therein, protrusions 32 penetrate and embed into the polymer layer 20. When protrusions 32 penetrate polymer layer 20, portions of layer 20 are caused to be displaced so as to surround protrusions 32. Accordingly, a secure and sealed connection between tube 12 and device 14 is created and maintained due to the elasticity of the polymer layer 20. As will be understood by one of ordinary skill in the art, protrusions 32 are circumferential in extent, and are configured to allow insertion. Once embedded, however, protrusions 32 are configured to resist removal. Accordingly, the radially innermost extent of protrusions 32 have a diameter 55 (shown in FIG. 6B) that is smaller, if only slightly, than the outside diameter 53 of tube 12.

In a second exemplary embodiment illustrated in FIGS. 12A and 12B wherein protrusions 32′ have a bead or ridge shape, as the end of tube 12 is inserted into fitting 28′, protrusions 32′ press, but do not penetrate, into layer 20. When protrusions 32′ press into layer 20, portions of layer 20 are caused to be displaced so as to surround protrusions 32′. Accordingly, a tight seal and connection between fitting 28 and tube 12 is created and maintained due to the elasticity of polymer layer 20. Accordingly, the radially innermost extent of protrusions 32′ have a diameter 55′ that is smaller, if only slightly, than the outside diameter 53 of tube 12. This embodiment is especially suited for systems wherein tube 12 has a relatively thin polymer coating (i.e., on the order of 0-500 μm, for example) such that the barbs described above could potentially damage or otherwise compromise the integrity of the coating. Thus, in this embodiment, the ridges serve to create a tight connection without penetrating and embedding into the polymer layer.

In yet another alternate preferred embodiment illustrated in FIGS. 8A, 8B, 9A, 9B, 13A and 13B, fitting 28″ has a male portion 34 and a female portion 50. As with the embodiment described above and shown in FIGS. 6A, 6B, 7A and 7B, female portion 50 includes a plurality of protrusions 32₁ protruding from its inner surface. Similarly, as with the embodiment described above and shown in FIGS. 3 and 5B, male portion 34 includes a plurality of protrusions 32, protruding from its outer surface that generally oppose protrusions 32. Additionally, male portion 34 also includes the stop feature 36 described above.

In this embodiment, as with the preferred embodiments described above, a portion of the inner surface of the open end 22 of tube 12 has a polymer layer 42 disposed thereon. As described above, in one embodiment, layer 42 is created by rolling the end of tube 12 into the center passageway 24 of tube 12 so as to provide for a portion of polymer layer 20 to be disposed within center passageway 24. Thus, in this particular embodiment, polymer layer 42 is formed of a portion of polymer layer 20. As shown in FIGS. 8A, 8B, 9A and 9B, to connect tube 12 and device 14 in this embodiment, the rolled end 22 of tube 12 is inserted and press-fit into female portion 50 of fitting 28″, and almost simultaneously press-fit over male portion 34 of fitting 28″. Accordingly, the diameter 51 of the opening of female portion 50 of fitting 28″ is greater than the outside diameter 53 of tube 12 (see also FIGS. 6A, 6B, 7A and 7B); and the body diameter 44 of the male portion 34 of fitting 28″ is less than the inside diameter 46 of tube 12 at the rolled end thereof (see also FIGS. 3-4).

In a first exemplary embodiment illustrated in FIGS. 8A, 8B, 9A and 9B wherein protrusions 32 take the form of barbs, as tube 12 is mated with fitting 28″, protrusions 32₁ of female portion 50 penetrate and embed in the outer polymer surface 20 of tube 12; and protrusions 32₂ of male portion 34 penetrate and embed in polymer layer 42 that is disposed within the central passageway 24 of tube 12, thereby creating a secure and sealed connection between tube 12 and device 14. Therefore, the radially innermost extent of protrusions 32₁ have a diameter 55 that is smaller, if only slightly, than the outside diameter 53 of tube 12, while the outermost extent of protrusions 32₂ have a diameter 48 that is larger, is only slightly, than the inside diameter 46 of the rolled end 22 of tube 12. In this embodiment, when fitting 28″ and tube 12 are fully mated together, portions of polymer layer 20 are caused to be displaced so as to surround protrusions 32₁. Additionally, portions of layer 42 are also caused to be displaced so as to surround protrusions 32₂. Thus, the interaction of layers 20 and 42 with protrusions 32₁ and 32₂ serve to create a secure and sealed connection between tube 12 and drive 14 that is created and maintained by the elasticity of layers 20 and 42.

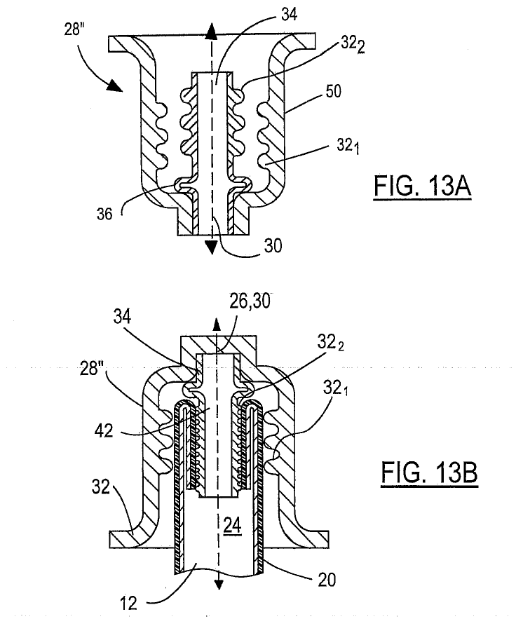

In a second exemplary embodiment illustrated in FIGS. 13A and 13B wherein the protrusions have a bead or ridge shape, as tube 12 is mated with fitting 28″, protrusions 32₁′ of female portion 50 press into the polymer layer 20 of tube 12. Similarly, protrusions 32₂′ of male portion 34 also press into the polymer layer 42. Accordingly, in this embodiment, protrusions 32₁′ and 32₂ ′ press, not penetrate/embed, into respective layers 20 and 42. Once fitting 28″ and tube 12 are fully mated together, portions of layer 20 are caused to be displaced so as to surround protrusions 32₁′. Similarly, once fitting 28″ and tube 12 are fully mated together, portions of layer 42 are caused to be displaced so as to surround protrusions 32₂′. Accordingly, the combination of male and female portions 34, 50 of fitting 28″ results in a tight seal and connection between fitting 28″ and tube 12 that is created and maintained by the elasticity of polymer layers 20 and 42. Therefore, the radially innermost extent of protrusions 32₁′ have a diameter 55′ (shown in FIG. 12A) that is smaller, if only slightly, than the outside diameter 53 of tube 12, while the outermost extent of protrusions 32₂′ have a diameter 48′ that is larger, is only slightly, than the inside diameter 46 (shown in FIG. 4) of the rolled end 22 of tube 12. This embodiment is especially suited for systems wherein tube 12 has a relatively thin polymer coating (i.e., on the order of 0-500 μm, for example) such that the barbs described above could potentially damage or otherwise compromise the integrity of the coating. Thus, in this embodiment, the ridges serve to create a tight connection without penetrating and embedding into the polymer layer.

In a third exemplary embodiment, the protrusions of one of either male portion 34 and female portion 50 take the form of barbs, while the protrusions of the other of male portion 34 and female portion 50 have the shape of beads or ridges. In this event, the respective descriptions above apply to this embodiment with equal force.

In each of the above described embodiments, the interaction of protrusions 32 and polymer layers 20 and/or 42 form a strong connection between tube 12 and device 14, and more importantly, create an improved seal between tube 12 and device 14 so as to prevent leakage of liquid or gas flowing through tube 12, as well as eliminating or substantially reducing the permeation of hydrocarbons through the joint between tube 12 and device 14, as compared to connection means such as those described in the Background above.

In any of the embodiments described above, the connection joint between tube 12 and device 14 may be further reinforced. For example, in one exemplary embodiment, the joint is crimped using known crimping methods (such as those described in co-pending and commonly assigned U.S. patent application Ser. No. 11/263,208, filed Oct. 31, 2005 entitled “Tank Assembly”, which is hereby incorporated by reference in its entirety). Alternatively, the joint could be subjected to additional processing, such as, for example, a magneforming operation (i.e., using pulsed electromagnetic fields to reshape metal), to further strengthen the connection between tube 12 and device 14. It should be noted that while only these two methods are described above, one of ordinary skill in the art will recognize that any method by which protrusions 32 can be caused to create a tighter seal and connection between tube 12 and device 14 remain within the spirit and scope of the present invention.

One exemplary application for the above described connection arrangements is in vehicular fuel systems such as the one illustrated in FIG. 1. In this exemplary embodiment, device 14 is comprised of a pair of fuel rails 14₁, 14₂, and tube 12 is a nylon coated aluminum alloy crossover tube that connects fuel rails 14₁ and 14₂ together. In one exemplary embodiment, tube 12 has a spiral convoluted portion 57 that provides flexibility to tube 12 to allow it, for example, to ben for ease of connection to the respective fuel rails.

As shown in the exemplary embodiment depicted in FIG. 1, fuel rail 14₁ includes an inlet 52. Inlet 52 allows a fuel rail 14₁ to receive pressurized fuel from a fuel pump (not shown). Fuel rail 14₁ has a series of outlets 54, and also includes a corresponding number of associated injector cups 56 that are configured to receive fuel injectors. Fuel rail 14₁ further includes an orifice outlet 58, which is provided with a fitting 28, wherein fitting 28 has a male portion 34 (shown in FIGS. 3 and 5B) having protrusions protruding therefrom. Fuel rail 14₁ may take the form of a rectangular tube (as shown), or may take on other shapes, such as, for example, a cylindrical tubular shape. Further, fuel rail 14₁ may be formed of any one of a number of materials, such as, for example, sheet metal, a high-temperature tolerant polymeric plastic material, or a polymer coated aluminum alloy tube. Fuel rail 14₂ is configured the same as fuel rail 14₁, with the exception that it does not have an inlet 52 for connecting to the fuel pump, and it may or may not have a fitting 28 having a male portion 34 having protrusions protruding therefrom associated therewith. Together, fuel rail 14₁ and 14₂ are operative to supply fuel to an internal combustion engine via a plurality of injectors (not shown).

To provide fluid communication of the fuel between the fuel rails 14₁ and 14₂, crossover tube 12 is connected between the orifice outlets 58 of each fuel rail. For an arrangement wherein both fuel rails 14₁ and 14₂ include a fitting 28 having male portion 34 having protrusions protruding therefrom, each end 60, 62 of crossover tube 12 has a polymer layer 42 disposed on the inner surface thereof. To connect crossover tube 12 and fuel rail 14₁, end 60 of crossover tube 12 is press-fit over male portion 34, and thus, protrusions 32. Similarly, to connect crossover tube 12 and fuel rail 14₂, and 62 is press-fit over male portion 34 of fitting 28 of fuel rail 14₂. Accordingly, as the ends of crossover tube 12 are pressed onto respective fittings 28, respective sets of protrusions 32 penetrate and embed into the portions of polymer layer 42.

In this exemplary application, when polymer layer 42 is exposed to hydrocarbons that are produced in the fuel system, the exposed portions of layer 42 will swell (as is discussed in great detail in co-pending and commonly assigned U.S. patent application Ser. No. 11/263,208, filed Oct. 31, 2005 entitled “Tank Assembly”, which was incorporated by reference in its entirety above). The swelling of the material will cause protrusions 32 to further penetrate and embed in layer 42 (when protrusions 32 take the form of barbs). Additionally, the presence of aluminum alloy core 16 will serve as a collar or band of sorts to prevent the expansion of the swelling so as to ensure the penetration of the protrusions 32 into polymer surface 42, thereby further strengthening the connection and seal between the fitting(s) and the fuel rail(s).

In an alternate embodiment, the connection site of crossover tube 12 and the respective fittings 28 may be further manipulated to increase the strength and seal of the connection. For example, as discussed above, the respective connections may be subjected to known means such as crimping or magneforming processes in order to cause protrusions 32 to further penetrate and embed in polymer layer 42.

The above described connections will provide a strong connection between the fuel rails and the tube, as well as a strong seal to prevent either leaking of fuel or permeation of hydrocarbons, both of which are undesirable and can be detrimental to a vehicular fuel delivery system.

In an alternate embodiment, fitting 28 is associated with the end or ends of crossover tube 12, rather than the orifices in the fuel rails. In such an embodiment, the same description set forth above applies with the only difference being that the polymer layers 20 and/or 42, as the case may be, are disposed on the fuel rail(s) rather than, or in addition to, being disposed on the crossover tube 12.

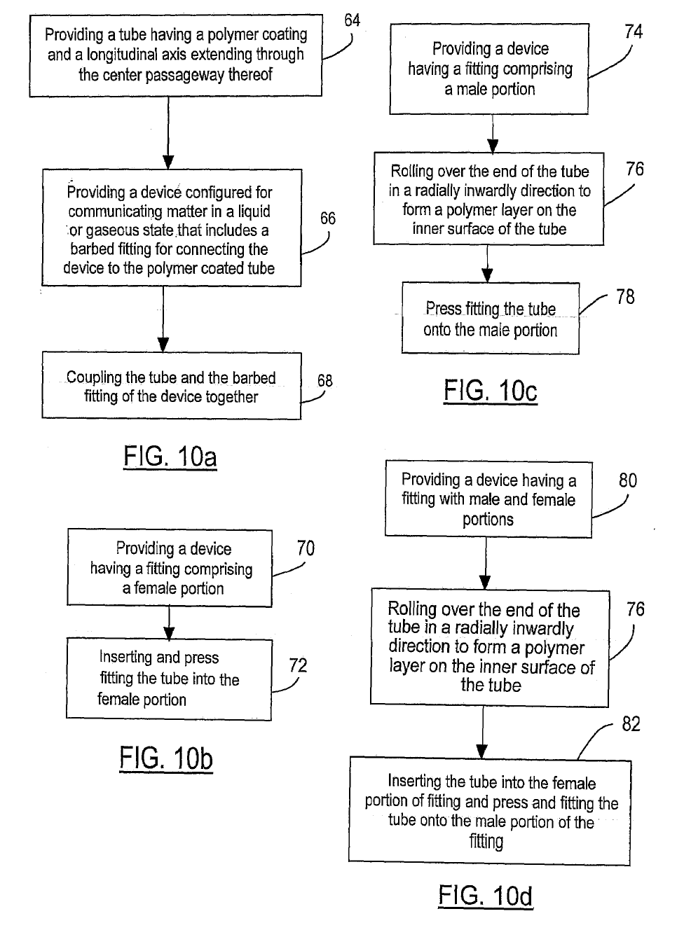

With respect to FIGS. 10A-10D, a method in accordance with the present invention is also provided. The broadest extent of the inventive method illustrated in FIG. 10a includes a first step 64 comprising providing a tube 12 having a polymer coating 20 and a longitudinal axis 26 extending through the center passageway 24 of tube 12. In one exemplary embodiment, tube 12 is a co-extruded nylon coated aluminum alloy tube.

In a second step 66, a device 14 is provided that is configured for communicating fluid (i.e., liquid or gas), and that includes at least one fitting 28 having protrusions 32 protruding therefrom for connecting device 14 to tube 12. In one exemplary embodiment, protrusions 32 take the form of barbs that are configured to penetrate and embed into the polymer coating of tube 12. In an alternate exemplary embodiment, protrusions 32 have the shape of beads or ridges and are configured to create press into the polymer coating of tube 12, rather than penetrating and embedding therein.

In a final step 68, tube 12 is coupled with fitting 28 so as to cause protrusions 32 of fitting 28 to create a tight seal and connection between tube 12 and device 14.

In a first embodiment illustrated in FIG. 10B of the broad method illustrated in FIG. 10A, step 64 includes the substep 70 of providing a device 14 having a fitting 28 which includes a female portion 50; and step 66 includes the substep 72 of inserting and press-fitting tube 12 into female portion 50.

In a second embodiment illustrated in FIG. 10C of the broad method illustrated in FIG. 10A, step 66 includes the substep 74 of providing a device 14 having a fitting 28 which includes a male portion 34. A further step 76 is included comprising rolling over the end of tube 12 in a radially inwardly direction relative to axis 26 into the center passageway 24 so as to cause a portion of polymer coating 20 to be disposed within the center passageway 24 of tube 12, thereby creating polymer layer 42 on the inner surface of tube 12. Additionally, step 68 further includes the substep 78 of press-fitting the rolled end of tube 20 onto male portion 34.

In a third embodiment illustrated in FIG. 10D of the broad method illustrated in FIG. 10A, step 66 includes the substep 80 of providing a device 14 having a fitting 28 comprising a female portion 50 and a male portion 34, wherein each portion has a plurality of protrusions 32 protruding therefrom. In this embodiment, which also includes step 76 described above, step 68 includes the substep 82 of press-fitting the rolled end of tube 12 both into the female portion 50 of fitting 28 and onto the male portion 34 of fitting 28. As tube 12 is mated with fitting 28, the protrusions 32₁ of female portion 50 create a tight seal and connection between female portion 50 of fitting 28 and tube 12, and the protrusions 32₂ of male portion 34 create a tight seal and connection between male portion 34 of fitting 28 and tube 12.

While the invention has been particularly shown and described with reference to the preferred embodiments thereof, it is well understood by those skilled in the art that various changes and modifications can be made in the invention without departing from the spirit and scope of the invention.

1. A connection arrangement for a tube, comprising:
a device configured to communicate fluid from an inlet to an outlet, said outlet including at least one fitting having a plurality of protrusions extending therefrom; and
a polymer coated tube comprising aluminum material coupled with said fitting of said device, said tube having an outer surface, an inner surface, at least one open end, a center passageway, and a longitudinal axis extending through said center passageway;
wherein said tube is configured to communicate said fluid, and said protrusions of said fitting are configured to create a tight seal and connection between said fitting and said tube.

2. The apparatus in accordance with claim 1 wherein said tube is a nylon coated aluminum alloy tube.

3. The apparatus in accordance with claim 1 wherein said polymer coating is disposed on the outer surface of said tube, said fitting includes a female portion, and said at least one open end of said tube is press fit into said female portion.

4. The apparatus in accordance with claim 1 wherein:
said fitting includes a male portion;
said at least one open end of said tube includes a polymer layer disposed on the inner surface thereof, and said at least one open end of said tube is press fit over said male portion.

5. The apparatus in accordance with claim 4 wherein each of said protrusions has a different diameter and said protrusions are arranged such that when said tube is press-fit over said male portion, said protrusions having the lesser diameters are inserted into said open end of said tube first and said diameters of said protrusions increase as said tube is further press-fit over each successive protrusion.

6. The apparatus in accordance with claim 4 wherein said fitting further includes a female portion, and said at least one open end of said tube is press-fit both onto said male portion and into said female portion.

7. The apparatus in accordance with claim 1 wherein said device is a pair of fuel rails and said tube is a crossover tube connecting said fuel rails together.

8. The apparatus in accordance with claim 1 wherein said protrusions take the form of barbs that are configured to penetrate and embed in said polymer coating when said tube and said device are mated together.

9. The apparatus in accordance with claim 1 wherein said protrusions have a ridge shape that are configured to press into the polymer coating of said tube when said tube and said device are mated together.

10. A fuel delivery system, comprising:
first and second fuel rails wherein at least one fuel rail includes an inlet for receiving pressurized fuel, and each of said fuel rails having an orifice to allow for fluid communications between said fuel rails; and
a polymer coated crossover tube comprising aluminum material configured to communicate fuel between said fuel rails, said tube having a connection at opposite ends with said respective fuel rails, said tube including an outer surface, an inner surface, a center passageway and a longitudinal axis extending therethrough;
wherein at least one of said first and second fuel rails includes a fitting having a plurality of protrusions protruding outwardly therefrom, said protrusions penetrating creating a tight seal and connection between said tube and said fitting.

11. The fuel delivery system of claim 10 wherein said polymer coating is disposed on the outer surface of said crossover tube, said fitting includes a female portion, and one end of said crossover tube is inserted into said female portion.

12. The fuel delivery system of claim 10 wherein:
said fitting includes a male portion and at least one end of said crossover tube includes a polymer coating disposed on a portion of the inner surface thereof; and
one end of said crossover tube is press fit over said male portion.

13. The fuel delivery system of claim 10 wherein each of said first and second fuel rails include a fitting having a plurality of protrusions protruding outwardly therefrom, said protrusions creating a tight seal and connection between said tube and said fitting at the respective ends of said crossover tube.

14. The fuel delivery system in accordance with claim 10 wherein said crossover tube is a nylon coated aluminum alloy tube.

15. The fuel delivery system in accordance with claim 10 wherein:
said fitting includes a male portion and a female portion;
at least one end of said crossover tube having a polymer coating disposed on the outer surface and on at least a portion of the inner surface thereof; and
said at least one end of said crossover tube is both press-fit onto said male portion and inserted into said female portion.

16. The fuel delivery system in accordance with claim 10 wherein said protrusions take the form that are configured to penetrate and embed in said polymer coating of said crossover tube.

17. The apparatus in accordance with claim 10 wherein said protrusions have a ridge shape that are configured to press into the polymer coating of said crossover tube.

18. A method of connecting a polymer coated tube to a device, comprising the steps of:
providing a tube comprising aluminum material having an outer surface, an inner surface, at least one open end, a polymer coating, and a center passageway, said tube further including a longitudinal axis extending through the center passageway;
providing a device configured to communicate fluid from an inlet to an outlet, said outlet including at least one fitting for connecting said device to said at least one open end of said tube so as to communicate said fluid between said tube and said device, said fitting including a plurality of protrusions protruding therefrom;
coupling said tube with said fitting of said device so as to cause said protrusions to create a tight seal and connection between said tube and said fitting.

19. A method in accordance with claim 18 wherein said polymer coating is disposed on the outer surface of said tube, and said step of providing a device includes providing a device wherein said fitting includes a female portion, said coupling step further includes inserting said tube into said female portion.

20. A method in accordance with claim 18 wherein:
said providing a tube step includes providing a tube wherein said at least one open end of said tube includes a polymer layer disposed on the inner surface thereof;
said step of providing a device includes providing a device wherein said fitting includes a male portion; and
said coupling step including the substep of press fitting said at least one open end of said tube onto said male portion.

21. A method in accordance with claim 20 further including the step of:
rolling over in a radially inwardly direction said at least one open end of said tube into said center passageway so as to cause a portion of said polymer coating to be disposed within said center passageway, thereby creating said polymer layer disposed on the inner surface of said tube.

22. A method in accordance with claim 20 wherein said step of providing a device includes providing a device having a fitting with both male and female portions, and said coupling step further includes the substep of inserting said tube into said female portion.

23. A method in accordance with claim 18 wherein said providing a tube step includes providing a nylon coated aluminum alloy tube.

24. A method in accordance with claim 18 further comprising the step of reinforcing the joint between said tube and said device.

25. A method in accordance with claim 24 wherein said reinforcing step includes subjecting said joint to at least one of a crimping and magneforming process.

26. A method in accordance with claim 18 wherein said providing a device step includes providing a device wherein said protrusions of said fitting take the form of barbs that are configured to penetrate and embed in said polymer coating.

27. A method in accordance with claim 18 wherein said providing a device step includes providing a device wherein said protrusions of said fitting have a ridge shape that are configured to press into the polymer coating of said tube when said tube and said device are mated together.
